(19) United States
(12) Patent Application Publication
(10) Pub. No.: US 2022/0247977 A1
(43) Pub. Date: Aug. 4, 2022

(54) VIDEO DOORBELL AND POWER SUPPLY METHOD THEREOF

(71) Applicant: PRIMAX ELECTRONICS LTD., Taipei City (TW)

(72) Inventor: TSAI-YU YU, Taipei City (TW)

(21) Appl. No.: 17/210,549

(22) Filed: Mar. 24, 2021

(30) Foreign Application Priority Data
Jan. 29, 2021 (TW) 110103477

(51) Int. Cl. H04N 7/18; H04N 5/232; H04W 52/02

(52) U.S. Cl. CPC H04N 7/186; H04W 52/0225; H04N 5/232411

(57) ABSTRACT

A power supply method for a video doorbell is provided. The video doorbell is electrically connected with an external power supply unit. The video doorbell includes a camera unit, a power storage unit and an actuation unit. The power supply method includes the following steps. If the actuation unit is triggered, the power storage unit provides electric power to the camera unit. If the actuation unit has been triggered for a time duration longer than a predetermined length of time, the power supply unit provides electric power to the camera unit.

### FIELD OF THE INVENTION

The present invention relates to a power supply method for a video doorbell, and more particularly to a power supply method capable of switching the source of providing electric power to a camera unit of a video doorbell.

### BACKGROUND OF THE INVENTION

A doorbell system is generally installed in a house or a place. When a visitor comes to visit the house or the place, the visitor may press a switch or a button of the doorbell system. Consequently, the doorbell system makes a sound to notify people inside the house or place. The doorbell system mainly comprises a power supply unit, a bell unit and an actuation unit.

As the smart home technology is vigorously developed and the demand on the home security is gradually increased, the doorbell system is additionally equipped with a camera unit to capture the image of the visitor. Generally, the camera unit and the actuation unit are integrated in the same casing to be collaboratively formed as a video doorbell.

In the existing design, the video doorbell is powered by an external power supply unit. That is, the external power supply unit provides AC power to the video doorbell. When a visitor presses a switch or a button of the doorbell system, the power supply unit changes the supplied power to the bell unit to allow the bell unit to generate a sound, but the power supply unit does not provide the power to the video doorbell. Under this circumstance, the video doorbell has to rely on the built-in battery to maintain the power-on state and avoid power interruption. However, since the video doorbell is usually installed in the outdoor environment, the use of the battery as the power supply is greatly restricted. For example, the battery is easily affected by temperature. The use of the battery at the high temperature has safety concern. In the low temperature environment (e.g., in a snowy environment), the battery cannot be charged and discharged. In other words, the existing design needs to be further improved.

### SUMMARY OF THE INVENTION

The present invention provides a video doorbell and a power supply method for the video doorbell. In addition, the present invention also provides a doorbell system and a power supply method for the doorbell system.

In accordance with an aspect of the present invention, a power supply method for a video doorbell is provided. The video doorbell is electrically connected with an external power supply unit. The video doorbell includes a camera unit, a power storage unit and an actuation unit. The power supply method includes the following steps. If the actuation unit is triggered, the power storage unit provides electric power to the camera unit. If the actuation unit has been triggered for a time duration longer than a predetermined length of time, the power supply unit provides electric power to the camera unit.

In an embodiment, the power supply unit includes an AC power source and a conversion circuit. The power storage unit is selected from one of a lithium carbon capacitor (LCC), a lithium ion capacitor (LIC) and an electrical double layer capacitor (EDLC).

In an embodiment, the predetermined length of time is in a range between 3 and 5 seconds.

In an embodiment, the actuating unit is one of a switch and a sensor.

In an embodiment, the video doorbell further includes a processing unit, and the processing unit calculates and judges whether the time duration that the actuation unit has been continuously triggered is longer than the predetermined length of time.

In accordance with another aspect of the present invention, a video doorbell is provided. The video doorbell is electrically connected with an external power supply unit. The video doorbell includes a camera unit, a power storage unit and an actuation unit. If the actuation unit is triggered, the power storage unit provides electric power to the camera unit. If the actuation unit has been triggered for a time duration longer than a predetermined length of time, the power supply unit provides electric power to the camera unit.

In an embodiment, the predetermined length of time is in a range between 3 and 5 seconds.

In an embodiment, the actuating unit is one of a switch and a sensor.

In an embodiment, the power supply unit includes an AC power source and a conversion circuit. The power storage unit is selected from one of a lithium carbon capacitor (LCC), a lithium ion capacitor (LIC) and an electrical double layer capacitor (EDLC).

In an embodiment, the video doorbell further includes a processing unit, and the processing unit calculates and judges whether the time duration that the actuation unit has been continuously triggered is longer than the predetermined length of time.

In accordance with another aspect of the present invention, a power supply method for a doorbell system is provided. The doorbell system includes power supply unit, a bell unit, a camera unit, a power storage unit and an actuation unit. The power supply method includes the following steps. If the actuation unit is triggered, the power storage unit provides electric power to the camera unit. If the actuation unit has been triggered for a time duration longer than a predetermined length of time, the power supply unit provides electric power to the camera unit.

In an embodiment, the power supply unit includes an AC power source and a conversion circuit. The power storage unit is selected from one of a lithium carbon capacitor (LCC), a lithium ion capacitor (LIC) and an electrical double layer capacitor (EDLC).

In an embodiment, the predetermined length of time is in a range between 3 and 5 seconds.

In an embodiment, the actuating unit is one of a switch and a sensor.

In an embodiment, the video doorbell further includes a processing unit, and the processing unit calculates and judges whether the time duration that the actuation unit has been continuously triggered is longer than the predetermined length of time.

In accordance with another aspect of the present invention, a doorbell system is provided. The doorbell system includes a power supply unit, a bell unit, a camera unit, a power storage unit and an actuation unit. If the actuation unit is triggered, the power storage unit provides electric power to the camera unit. If the actuation unit has been triggered for a time duration longer than a predetermined length of time, the power supply unit provides electric power to the camera unit.

In an embodiment, the predetermined length of time is in a range between 3 and 5 seconds.

In an embodiment, the actuating unit is one of a switch and a sensor.

In an embodiment, the power supply unit includes an AC power source and a conversion circuit. The power storage unit is selected from one of a lithium carbon capacitor (LCC), a lithium ion capacitor (LIC) and an electrical double layer capacitor (EDLC).

In an embodiment, the video doorbell further includes a processing unit, and the processing unit calculates and judges whether the time duration that the actuation unit has been continuously triggered is longer than the predetermined length of time.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit diagram illustrating a video doorbell according to an embodiment of the present invention; and

FIG. 2 is a flowchart illustrating a power supply method for the video doorbell according to an embodiment of the present invention.

### DETAILED DESCRIPTION OF THE PREFERRED EMBODIMENT

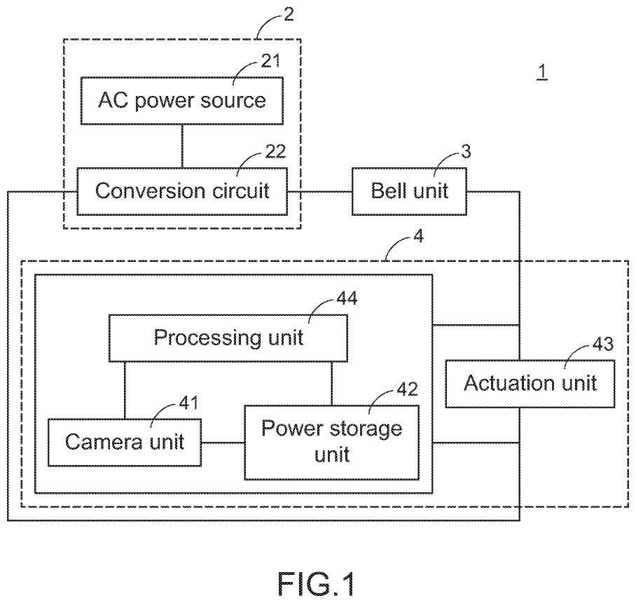

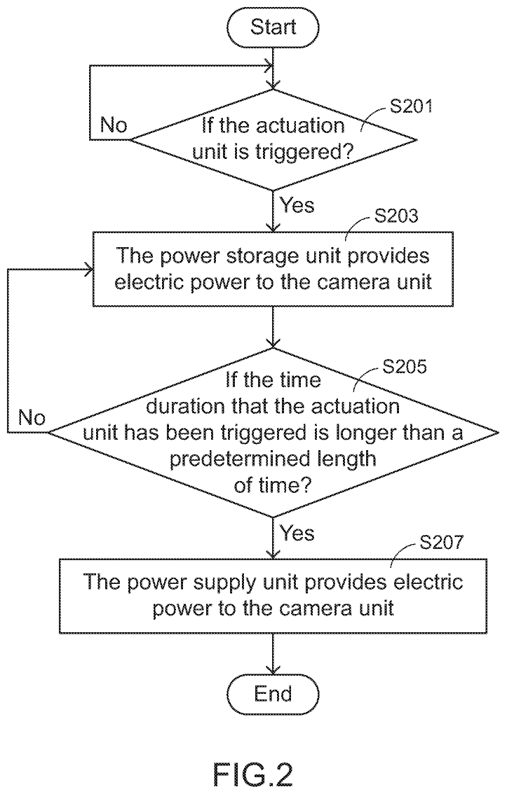

In a first embodiment of the present invention, a video doorbell and a power supply method for the video doorbell are provided. Please refer to FIGS. 1 and 2. The video doorbell 4 comprises a camera unit 41, a power storage unit 42, an actuation unit 43 and a processing unit 44. The video doorbell 4 can be installed on an outside location of a house or a place. In addition, the video doorbell 4 can be electrically connected to a power supply unit 2 and a bell unit 3. The power supply unit 2 and the bell unit 3 are independently located outside the video doorbell 4 and arranged installed on an inside location of the house or the place. In other words, for the video doorbell 4, the power supply unit 2 and the bell unit 3 are external units or components, rather than the built-in components. The power supply unit 2 comprises an AC power source 21 and a conversion circuit 22. The AC power source 21 can provide an AC voltage such as 110V to 220V. By the conversion circuit 22, the voltage from the AC power source 21 is converted into an AC voltage suitable for the doorbell (e.g., 8V˜24V). When the actuating unit 43 is triggered, the bell unit 3 makes a buzzer or another type of sound to remind the people in the house or the place.

The camera unit 41 is an image pickup device for capturing an external image such as the face image of a visitor, an image at a certain angle or an image of a certain region. The power storage unit 42 can be selected from a lithium carbon capacitor (LCC), a lithium ion capacitor (LIC) or an electrical double layer capacitor (EDLC). The uses of these capacitors can achieve the rapid charging and discharging purpose without the high and low temperature limitations. In addition, these capacitors have many advantages over batteries. When the lithium carbon capacitor (LCC), the lithium ion capacitor (LIC) or the electrical double layer capacitor (EDLC) is installed in the video doorbell 4, the storage capacity of the lithium carbon capacitor (LCC), the lithium ion capacitor (LIC) or the electrical double layer capacitor (EDLC) is only enough to allow the camera unit 41 to be operated for about 13 seconds. Therefore, the present invention additionally provides a protection mechanism. Due to the protection mechanism, the camera unit 41 is not powered off even if the storage capacity of the capacitor is quickly exhausted.

Preferably but not exclusively, the actuating unit 43 is a switch or a sensor. The switch can be selected from a reset button switch or any other general switch that is applicable to doorbells. When the switch is operated (e.g., pressed by the user), the actuation unit 43 is triggered. In addition, the sensor can be a non-contact sensor or a contact sensor. For example, the sensor is a human sensor, a radar, an optical sensor, a touch sensor, or the like. The type of the sensor of the actuation unit 43 may be determined according to the practical requirements. The actuation unit 43 can be triggered by the visitor, or the actuation unit 43 can be automatically triggered after the presence of the visitor is sensed. The processing unit 44 is electrically connected with the camera unit 41, the power storage unit 42 and the actuation unit 43.

In this embodiment, the camera unit 41, the power storage unit 42, the actuation unit 43 and the processing unit 44 are assembled in the same casing to be collaboratively formed as the video doorbell 4. In some other embodiments, the actuation unit 43 could be arranged outside the casing of the video doorbell 4. In addition, the actuation unit 43 can be connected with the camera unit 41, the power storage unit 42 and the processing unit 44 through wired electrical connection or wireless signal transmission. It is noted that way of establishing the connection between the actuation unit and the associated components is not restricted.

FIG. 2 is a flowchart illustrating a power supply method for the video doorbell according to an embodiment of the present invention.

Firstly, in a step S201, the processing unit 44 judges whether the actuation unit 43 is triggered.

If the judging result of the step S201 indicates that the actuation unit 43 is triggered, a step S203 is performed. In the step S203, the processing unit 44 controls the power storage unit 42 to provide electric power to the camera unit 41.

Whereas, if the judging result of the step S201 indicates that the actuation unit 43 is not triggered, the step S201 is repeatedly done.

After the step S203, a step S205 is performed. In the step S205, the processing unit 44 continuously monitors the actuation unit 43, calculates a time duration that the actuation unit 43 has been continuously triggered, and judges whether the time duration is longer than a predetermined length of time.

If the processing unit 44 monitors that the actuation unit 43 has been triggered for a duration longer than the predetermined length of time, the processing unit 44 judges that the triggering event is caused by a visitor's erroneous operation or an intentional behavior. Then, a step S207 is performed. In the step S207, the processing unit 44 controls the external power supply unit 2 to provide electric power to the camera unit 41 in order to prevent the stored power of the power storage unit 42 from being exhausted.

Whereas, if the processing unit 44 judges that the actuation unit 43 has been continuously triggered for the duration shorter than the predetermined length of time, the step S203 is repeatedly done. Meanwhile, the power storage unit 42 still provides the electric power to the camera unit 41.

In the power supply method for the video doorbell, the predetermined length of time is in the range between 3 and 13 seconds, and preferably in the range between 3 and 5 seconds. Since the present invention provides the protection design of switching the source of providing electric power to the camera unit, the storage capacity of the lithium carbon capacitor (LCC), the lithium ion capacitor (LIC) or the electrical double layer capacitor (EDLC) will not be exhausted and the camera unit 41 will not be powered off.

In a second embodiment of the present invention, a doorbell system and a power supply method for the doorbell system are provided. Please refer to FIGS. 1 and 2. The doorbell system 1 comprises a power supply unit 2, a bell unit 3, a camera unit 41, a power storage unit 42, an actuation unit 43 and a processing unit 44. The above components (or units) can be electrically connected with each other. The power supply unit 2 and the bell unit 3 are installed on an inside location of a house or a place. The camera unit 41, the power storage unit 42, the actuation unit 43 and the processing unit 44 are installed on an outside location of the house or the place.

The power supply unit 2 comprises an AC power source 21 and a conversion circuit 22. The AC power source 21 can provide an AC voltage such as 110V to 220V. By the conversion circuit 22, the voltage from the AC power source 21 is converted into an AC voltage suitable for the doorbell (e.g., 8V˜24V). When the actuating unit 43 is triggered, the bell unit 3 makes a buzzer or another type of sound to remind the people in the house or the place.

The camera unit 41 is an image pickup device for capturing an external image such as the face image of a visitor, an image at a certain angle or an image of a certain region. The power storage unit 42 can be selected from a lithium carbon capacitor (LCC), a lithium ion capacitor (LIC) or an electrical double layer capacitor (EDLC). The uses of these capacitors can achieve the rapid charging and discharging purpose without the high and low temperature limitations. In addition, these capacitors have many advantages over batteries. When the lithium carbon capacitor (LCC), the lithium ion capacitor (LIC) or the electrical double layer capacitor (EDLC) is adapted in the doorbell system 1, the storage capacity of the lithium carbon capacitor (LCC), the lithium ion capacitor (LIC) or the electrical double layer capacitor (EDLC) is only enough to allow the camera unit 41 to be operated for about 13 seconds. Therefore, the present invention additionally provides a protection mechanism. Due to the protection mechanism, the camera unit 41 is not powered off even if the storage capacity of the capacitor is quickly exhausted.

Preferably but not exclusively, the actuating unit 43 is a switch or a sensor. The switch can be selected from a reset button switch or any other general switch that is applicable to doorbells. When the switch is operated (e.g., pressed by the user), the actuation unit 43 is triggered. In addition, the sensor can be a non-contact sensor or a contact sensor. For example, the sensor is a human sensor, a radar, an optical sensor, a touch sensor, or the like. The type of the sensor of the actuation unit 43 may be determined according to the practical requirements. The actuation unit 43 can be triggered by the visitor, or the actuation unit 43 can be automatically triggered after the presence of the visitor is sensed. The processing unit 44 is electrically connected with the camera unit 41, the power storage unit 42 and the actuation unit 43.

In this embodiment, the camera unit 41, the power storage unit 42, the actuation unit 43 and the processing unit 44 are assembled in the same casing to be collaboratively formed as a video doorbell 4. In some other embodiments, the actuation unit 43 could be arranged outside the video doorbell 4. In addition, the actuation unit 43 can be connected with the camera unit 41, the power storage unit 42 and the processing unit 44 through wired electrical connection or wireless signal transmission. It is noted that way of establishing the connection between the actuation unit and the associated components is not restricted.

The power supply method for the doorbell system will be illustrated with reference to FIG. 2.

Firstly, in a step S201, the processing unit 44 judges whether the actuation unit 43 is triggered.

If the judging result of the step S201 indicates that the actuation unit 43 is triggered, a step S203 is performed. In the step S203, the processing unit 44 controls the power storage unit 42 to provide electric power to the camera unit 41.

Whereas, if the judging result of the step S201 indicates that the actuation unit 43 is not triggered, the step S201 is repeatedly done.

After the step S203, a step S205 is performed. In the step S205, the processing unit 44 continuously monitors the actuation unit 43, calculates a time duration that the actuation unit 43 has been continuously triggered, and judges whether the time duration is longer than a predetermined length of time.

If the processing unit 44 monitors that the actuation unit 43 has been triggered for the predetermined length of time, the processing unit 44 judges that the triggering event is caused by a visitor's erroneous operation or an intentional behavior. Then, a step S207 is performed. In the step S207, the processing unit 44 controls the external power supply unit 2 to provide electric power to the camera unit 41 in order to prevent the stored power of the power storage unit 42 from being exhausted.

Whereas, if the processing unit 44 judges that the actuation unit 43 has been continuously triggered for the time duration shorter than the predetermined length of time, the step S203 is repeatedly done. Meanwhile, the power storage unit 42 still provides the electric power to the camera unit 41.

In the power supply method for the doorbell system, the predetermined length of time is in the range between 3 and 13 seconds, and preferably in the range between 3 and 5 seconds. Since the present invention provides the protection design of switching the source of providing electric power to the camera unit, the storage capacity of the lithium carbon capacitor (LCC), the lithium ion capacitor (LIC) or the electrical double layer capacitor (EDLC) will not be exhausted and the camera unit 41 will not be powered off.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A power supply method for a video doorbell, the video doorbell being electrically connected with an external power supply unit, the video doorbell comprising a camera unit, a power storage unit and an actuation unit, the power supply method comprising steps of:
if the actuation unit is triggered, allowing the power storage unit to provide electric power to the camera unit; and
if the actuation unit has been triggered for a time duration longer than a predetermined length of time, allowing the power supply unit provides electric power to the camera unit.

2. The power supply method according to claim 1, wherein the power supply unit comprises an AC power source and a conversion circuit, wherein the power storage unit is selected from one of a lithium carbon capacitor (LCC), a lithium ion capacitor (LIC) and an electrical double layer capacitor (EDLC).

3. The power supply method according to claim 1, wherein the predetermined length of time is in a range between 3 and 5 seconds.

4. The power supply method according to claim 1, wherein the actuating unit is one of a switch and a sensor.

5. The power supply method according to claim 1, wherein the video doorbell further comprises a processing unit, and the processing unit calculates and judges whether the time duration that the actuation unit has been continuously triggered is longer than the predetermined length of time.

6. A video doorbell electrically connected with an external power supply unit, the video doorbell comprising:
a camera unit;
a power storage unit; and
an actuation unit,
wherein if the actuation unit is triggered, the power storage unit provide electric powers to the camera unit, wherein if the actuation unit has been triggered for a time duration longer than a predetermined length of time, the power supply unit provides electric power to the camera unit.

7. The video doorbell according to claim 6, wherein the predetermined length of time is in a range between 3 and 5 seconds.

8. The video doorbell according to claim 6, wherein the actuating unit is one of a switch and a sensor.

9. The video doorbell according to claim 6, wherein the power supply unit comprises an AC power source and a conversion circuit, wherein the power storage unit is selected from one of a lithium carbon capacitor (LCC), a lithium ion capacitor (LIC) and an electrical double layer capacitor (EDLC).

10. The video doorbell according to claim 6, wherein the video doorbell further comprises a processing unit, and the processing unit calculates and judges whether the time duration that the actuation unit has been continuously triggered is longer than the predetermined length of time.

11. A power supply method for a doorbell system, the doorbell system comprising power supply unit, a bell unit, a camera unit, a power storage unit and an actuation unit, the power supply method comprising steps of:
if the actuation unit is triggered, allowing the power storage unit to provide electric power to the camera unit; and
if the actuation unit has been triggered for a time duration longer than a predetermined length of time, allowing the power supply unit provides electric power to the camera unit.

12. The power supply method according to claim 11, wherein the power supply unit comprises an AC power source and a conversion circuit, wherein the power storage unit is selected from one of a lithium carbon capacitor (LCC), a lithium ion capacitor (LIC) and an electrical double layer capacitor (EDLC).

13. The power supply method according to claim 11, wherein the predetermined length of time is in a range between 3 and 5 seconds.

14. The power supply method according to claim 11, wherein the actuating unit is one of a switch and a sensor.

15. The power supply method according to claim 11, wherein the doorbell system further comprises a processing unit, and the processing unit calculates and judges whether the time duration that the actuation unit has been continuously triggered is longer than the predetermined length of time.

16. A doorbell system, comprising:
a power supply unit;
a bell unit;
a camera unit;
a power storage unit; and
an actuation unit,
wherein if the actuation unit is triggered, the power storage unit provide electric powers to the camera unit, wherein if the actuation unit has been triggered for a time duration longer than a predetermined length of time, the power supply unit provides electric power to the camera unit.

17. The doorbell system according to claim 16, wherein the predetermined length of time is in a range between 3 and 5 seconds.

18. The doorbell system according to claim 16, wherein the actuating unit is one of a switch and a sensor.

19. The doorbell system according to claim 16, wherein the power supply unit comprises an AC power source and a conversion circuit, wherein the power storage unit is selected from one of a lithium carbon capacitor (LCC), a lithium ion capacitor (LIC) or an electrical double layer capacitor (EDLC).

20. The doorbell system according to claim 16, wherein the video doorbell further comprises a processing unit, and the processing unit calculates and judges whether the time duration that the actuation unit has been continuously triggered is longer than the predetermined length of time.
